(19) United States
(12) Patent Application Publication
(10) Pub. No.: US 2019/0368865 A1
(43) Pub. Date: Dec. 5, 2019

(54) METHOD FOR DERIVING VARIED-RESOLUTION 3D INFORMATION FROM 2D IMAGES

(71) Applicant: Carbon Robotics, Inc., San Francisco, CA (US)

(72) Inventors: Daniel Corkum, San Francisco, CA (US); Rosanna Myers, San Francisco, CA (US)

(21) Appl. No.: 16/427,326

(22) Filed: May 30, 2019

Related U.S. Application Data
(60) Provisional application No. 62/678,168, filed on May 30, 2018.

(51) Int. Cl. G01B 11/25; B25J 9/16; G01B 11/02; G06T 7/521

(52) U.S. Cl. CPC G01B 11/2509; G01B 11/2522; G06T 7/521; G01B 11/026; B25J 9/1697

(57) ABSTRACT

Once variation of a method for deriving varied-resolution 3D information from 2D images includes: recording a 2D color near-field image through a first color camera arranged on a robotic arm proximal an end effector, characterized by first focal length, and defining a narrow field of view containing an interaction surface on the end effector; recording a 2D color wide-field image through a second color camera arranged on the robotic arm, characterized by a second focal length less than the first focal length, and defining a wide field of view containing the narrow field of view and a greater region of a working volume; and reconstructing a first portion of a 3D image of the working volume proximal the interaction surface at a first resolution from the 2D color near-field image and a first region of the 2D color wide-field image that overlaps the 2D color near-field image.

### CROSS-REFERENCE TO RELATED APPLICATIONS

This Application claims the benefit of U.S. Provisional Application No. 62/678,168, filed on 30 May 2018, which is incorporated in its entirety by this reference.

### TECHNICAL FIELD

This invention relates generally to the field of robotic arms and more specifically to a new and useful method for deriving varied-resolution 3D information from 2D images in the field of robotic arms.

### BRIEF DESCRIPTION OF THE FIGURES

FIG. 1 is a flowchart representation of a method;

FIG. 2 is a flowchart representation of one variation of the method;

FIG. 3 is a flowchart representation of one variation of the method; and

FIG. 4 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

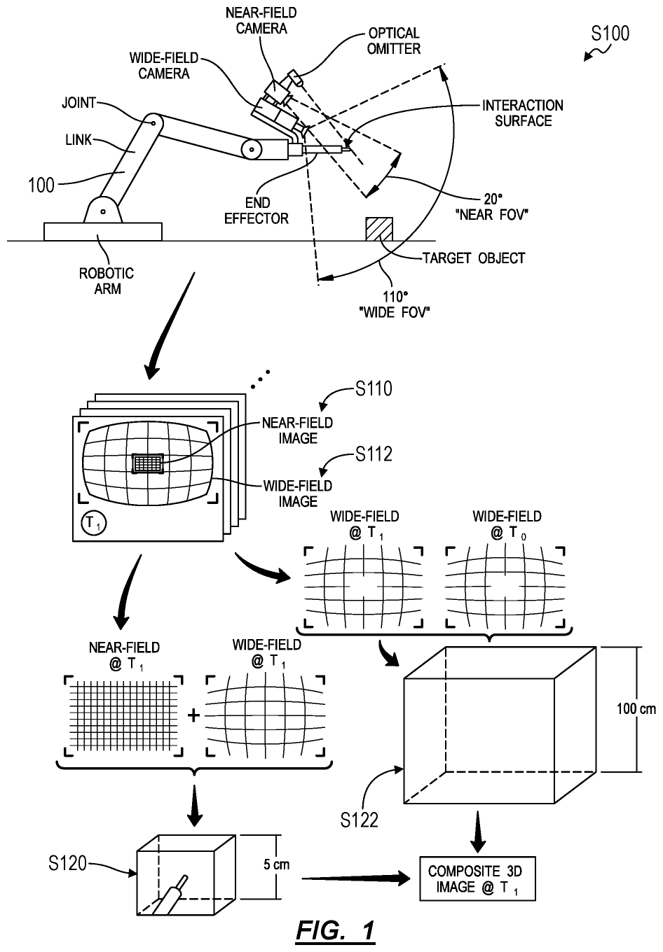

As shown in FIG. 1, a method S100 for deriving varied-resolution 3D information from 2D images includes: at a first time, recording a 2D color near-field image through a first color camera arranged on a robotic arm proximal an end effector, the first color camera characterized by a first focal length and defining a narrow field of view containing an interaction surface on the end effector in Block S110; at a second time approximating the first time, recording a 2D color wide-field image through a second color camera arranged on the robotic arm, the second color camera characterized by a second focal length less than the first focal length and defining a wide field of view containing the narrow field of view and a greater region of a working volume of the robotic arm in Block S112; reconstructing a first portion of a 3D image of the working volume proximal the interaction surface at a first resolution from the 2D color near-field image and a first region of the 2D color wide-field image that overlaps the 2D color near-field image in Block S120; and reconstructing a second portion of the 3D image at a second resolution less than the first resolution from the 2D color wide-field image and recent 2D color wide-field images output by the second color camera in Block S122.

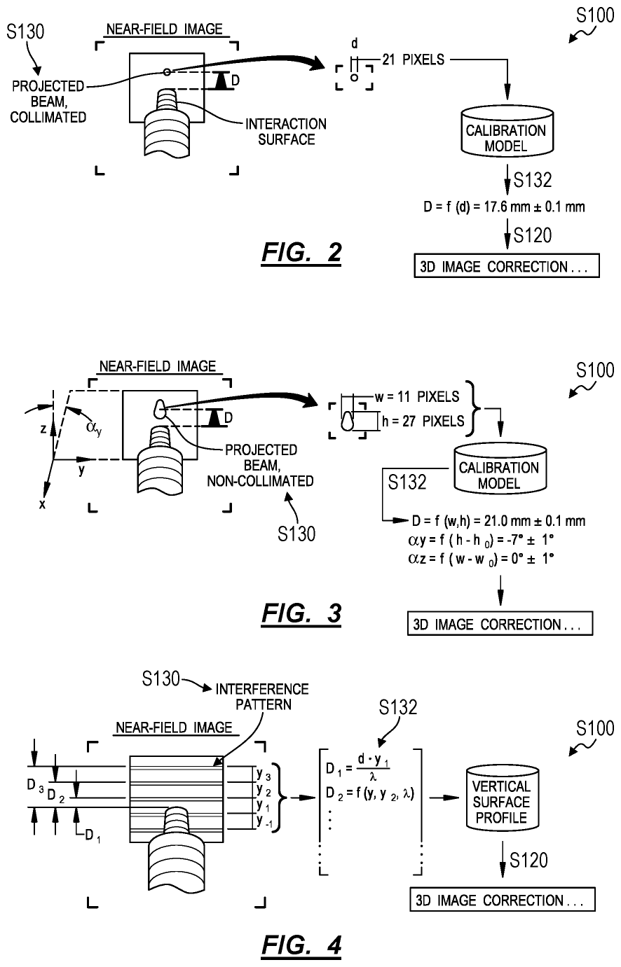

One variation of the method S100 shown in FIGS. 2-4 also includes: at the first time, projecting a light pattern into the narrow field of view of the first color camera, the light pattern characterized by a frequency detectable by the first color camera in Block S130; detecting the light pattern in the 2D color near-field image; and calculating a distance from the first color camera to a surface in the narrow field of view based on a geometry of the light pattern detected in the 2D color near-field image in Block S132. In this variation, the method can also include projecting the distance into the 3D image and forcing reconstruction of the first position of the 3D image according to the distance in Block S120.

### 2. System

Generally, the method S100 can be executed by a system including a robotic arm—including a set of color cameras characterized by substantially different intrinsic properties—to reconstruct a 3D image of a working field around the robotic arm from 2D color images recorded by thee color cameras. Furthermore, the system can implement the method S100 to leverage the varied intrinsic properties of these color cameras, their varied fields of view, and the resolutions of 2D color images output thereby to construct 3D images that exhibit varied resolutions across the working field as a function of the proximity to a particular surface on the robotic arm configured to interact with (i.e., engage, contact) external objects or surfaces in the working field.

For example, the system can implement Blocks of the method S100 substantially in real-time: to fuse a near-field image output by a near-field camera and a wide-field image output by a wide-field camera—both arranged on the robotic arm at a known offset and defining fields of view that overlap at an interaction surface on the end effector—into a high-resolution 3D image (e.g., a 3D point cloud) that represents objects near the interaction surface, such as by implementing 3D reconstruction techniques; to transfer the remainder of the wide-field image into a lower-resolution 3D image of objects within the field of view of the wide-field camera but not in the field of view of the near-field camera, such as by implementing structure from motion techniques; and to compile the high-resolution 3D image and the lower-resolution 3D image into a 3D, varied-resolution representation of an operating volume around the robotic arm. To globally navigate the end effector within the operating volume of the robotic arm—such as over relatively large distances between two target objects or target surfaces within the operating volume—the system can register motion of the robotic arm globally to surfaces represented loosely (i.e., within lower resolution) in the lower-resolution 3D image and/or control motion of joints in the robotic arm based on positions read directly from sensors in these joints, either of which may be relatively imprecise but which may also enable the system to move the robotic arm faster and with less computation. However, as the interaction surface on the end effector nears a target object or target surface, the system can transition to registering local motion of the robotic arm to this target object or target surface, which may be represented with high fidelity and high locational accuracy in the high-resolution 3D image, thereby enabling the system to precisely (i.e., accurately and repeatably) navigate the interaction surface of the end effector into contact with the target object or target surface.

Therefore, by leveraging two color cameras exhibiting different intrinsic and/or extrinsic properties (e.g., a near-field camera and a wide-field camera), the system can generate a 3D image that represents objects and surfaces—within the operating volume of the robotic arm—at varied resolutions matched to proximity to the interaction surface, thereby enabling the system to simultaneously achieve both: high-focus vision for precise perception of the position of the interaction surface relative to a target object or target surface; and peripheral vision for lower-precision perception of static and dynamic objects and/or surfaces within a larger operating volume of the robotic arm.

In one variation, the system also includes an optical emitter mounted to the robotic arm (e.g., to the end effector adjacent the near-field camera) and configured to project light into the field of view of the near-field camera. The output frequency of the optical emitter can be matched to a sensible frequency of the near-field camera such that light output by the optical emitter and incident on a surface in the field of view of the near-field camera may be recorded in a 2D color image output by the near-field camera. The system can then detect the position and/or geometry of this light—incident on the surface—represented in the 2D color image and derive a distance from the optical emitter (or from the near-field camera) to the surface at the location of this incident light within a relatively high degree of resolution and precision (e.g., 500 microns±100 microns when the near-field camera is within ten centimeters of the surface). The system can then incorporate this distance value as a ground truth or reference distance in a 3D image reconstructed from concurrent near-field and wide-field images to improve accuracy of distances to other surfaces represented in the 3D image.

The system can therefore leverage a color camera arranged on the robotic arm to record and configured to output 2D color images to simultaneously record light—output by a controlled optical emitter in the system—incident on surfaces in the field of view of this color camera. The system can then interpret a distance from a point or surface in the field to the camera (or to the optical emitter) based on a geometry of this light detected in a 2D color image and compile both this distance value and features extracted from the 2D image into a 3D image, such as a 3D point cloud or color depth map, thereby enabling the color camera to record data representing an additional dimension.

### 3. Robotic Arm

The method S100 is described below as executed by a system including a robotic arm, as shown in FIG. 1. The robotic arm can include multiple actuatable joints interposed between multiple beam sections and independently manipulatable to move an end effector mounted to a far end of the robotic arm. Each joint can define one or more actuatable axes driven by an internal actuator (e.g., a servo motor) or by a remote actuator, such as a gearhead motor arranged in a base of the robotic arm and coupled to the joint by a set of tensioned cables. Throughout operation, the system can selectively actuate these joints to move the end effector through a trajectory to engage, move, or otherwise interact with a target object or surface. In particular, the end effector can include an interaction surface configured to engage, contact, modify, or otherwise interact with an external target object or external target surface within a working volume of the robotic arm, and the system can manipulate the joints to move the interaction surface into and out of contact with these target objects and/or target surfaces and to move the interaction surface between such target objects and/or target surfaces.

### 4. Cameras

As shown in FIG. 1, the system can also include one or more cameras mounted to the robotic arm. The system can regularly process images recorded by these cameras in (near) real-time to detect a reference feature in a field around the robotic arm, determine a pose of the end effector relative to this reference feature, and then drive actuators in the robotic arm to move the end effector in real space relative to this reference feature, such as to engage a target object or to place a target object in a new target position.

The cameras can be mounted to the robotic arm, such as on a beam furthest from the base, in a joint between the furthest beam and the end effector, or in the end effector itself. Each camera can include a color (e.g., RGB), infrared, multispectral, monochromatic, other type of optical sensor configured to output images of a field of view of the camera. For example, each camera can output digital photographic color images at a frame rate of 24 frames per second throughout operation of the robotic arm, and the cameras can be synchronized to output concurrent images sets. Furthermore, each camera can exhibit different intrinsic and/or extrinsic properties—such as focal length, aperture, and optical distortion—to enable the system to collect optical data over various fields, over various distances from the robotic arm, and at various resolutions. For example, the system can include both a near-field camera with a relative long focal length and a wide-field camera with a relatively short focal length. The system can then merge 2D images output by the near-field camera and the wide-field camera into a 3D image containing higher-resolution 3D representation of a narrow region of the robotic arm's operating volume (e.g., near the end effector) and a lower-resolution 3D representation of a field around the robotic arm outside of this narrow region. The system can then: execute high-accuracy local movements (e.g., near a target object or target surface) based on the higher-resolution data in the 3D image; and execute lower-accuracy global movements (e.g., when not interacting with or approaching a target object or target surface) based on the lower-resolution data in the 3D image.

The system can also store empirical intrinsic properties of the camera, such as focal length, image sensor format, principal point, lens distortion, and/or entrance pupil (or nodal point). The system can then access any one or more of these intrinsic properties to correct images received from the camera and/or to transform data extracted from these images into a pose of the end effector, a particular joint in the robotic arm, or the end effector mounted to the end of the robotic arm.

### 4.1 Near-Field Camera

In one implementation, the system includes a near-field camera coupled to the end effector and defining a relatively small field of view around the interaction surface of the end effector. In particular, the near-field camera can define a relatively narrow field of view that encompasses the interaction surface on the end effector and a small region around the interaction surface at a working plane parallel to the focal plane of the near-field camera and intersecting the interaction surface. For example, the near-field camera can include a color (e.g., RGB) or black-and-white camera with a telephoto lens—characterized by a relatively long focal length (e.g., 33 millimeters)—that yields an effective field of view over a five-centimeter-square area with minimal distortion (e.g., barrel distortion) at the working plane. In this example, the near-field camera can also be fixedly coupled to the end effector with its field of view centered on the interaction surface of the end effector.

Because the near-field camera exhibits a relatively narrow field of view for the area of its image sensor, the near-field camera can output high-resolution near-field color images—that is, color images containing pixels that each represent a relatively small real area or real length (e.g., a 50-micron-square area at the working plane per pixel). A near-field image recorded by the near-field camera can therefore contain sufficient resolution to enable the system to: identify a target surface near the working plane; and register motion of the interaction surface on the end effector to this target surface—such as described in U.S. patent application Ser. No. 15/707,648—with tight positional tolerance (e.g., ±500 microns). In particular, as the end effector—and therefore the near-field camera and the interaction surface—approach a target surface, the system can register local or “micro” movements of the robotic arm to the target surface given high-resolution near-field images output by the near-field camera. By thus registering motion of the robotic arm—or the end effector or the interaction surface more specifically—to a target object detected in a near-field image, the system can accurately and repeatably navigate the interaction surface to the target object. For example, by registering motion of the end effector—or the interaction surface more specifically—to a target object or target surface detected in a high-resolution narrow-field image output by the near-field camera, the system can autonomously precisely manipulate even very small objects—such as millimeter-scale fasteners—through the robotic arm.

The system can therefore: collect high-resolution, narrow-field optical data—targeted to the interaction surface on the end effector—through the near-field camera; and leverage the high-resolution to calculate and then execute small, local changes in the positions of joints in the robotic arm to close a final gap between the interaction surface and a target surface or target object in the working volume of the robotic arm, such as over a last four centimeters to contact between the interaction surface and the target object.

### 4.2 Wide-Field Camera

The system can also include a wide-field camera coupled to the end effector and defining a relatively wide field of view that overlaps and extends (well) beyond the field of view of the near-field camera. For example, the wide-field camera can include a color (e.g., RGB) or black-and-white camera with a wide-angle lens—characterized by a relatively short focal length (e.g., 2.5 millimeters)—that yields a wide field of view of approximately 90 degrees. Because the wide-field camera defines a larger field of view than the near-field camera, the system can collect optical data representative of surfaces within a greater operating volume of the robotic arm via the near-field camera and thus perceive motion of the end effector within this greater operating volume accordingly.

In particular, the wide-field camera can define a wider field of view that enables the system to collect lower-resolution optical data over a wider span of the operating volume of the robotic arm. For example, a wide-field image recorded by the wide-field camera may yield insufficient density of data to enable the system to tightly reference motion of the end effector to an external surface represented in this wide-field image. However, by capturing optical data over a larger field than the near-field camera, the wide-field camera can enable the system: to detect features within a greater field around the robotic arm; and to register global or “macro” movements of the robotic arm to these features, such as when driving the end effector toward a target object and before the target object falls within the field of view and/or within a functional distance of the near-field camera. Once the target object falls within the field of view of the near-field camera, the system can transition to registering local motion of the end effector to the target object represented in high-resolution near-field cameras recorded by the near-field camera and execute local or “micro” movements at the robotic arm relative to the target object accordingly, such as described in U.S. patent application Ser. No. 15/707,648.

Therefore, by incorporating the wide-field camera, the system can: determine its position and track its global movements—between interactions within external objects and/or external surfaces—relative to global features within its operating field with a low or moderate degree of accuracy based on positions and geometries of global features detected in wide-field images recorded by the wide-field camera; and thus achieve gross positional accuracy as the system moves the end effector between interactions within external target surfaces based on optical data recorded by the wide-field camera. However, by incorporating the near-field camera, the system can also: determine its position and track its local movements relative to an external target object—upon immediate approach to this target object—with a high degree of accuracy based on local features detected in near-field images recorded by the near-field camera; and thus achieve acute positional accuracy as the system moves the end effector into contact with the target surface.

### 4.3 Near-Field Camera and Wide-Field Camera Positions

In the foregoing implementation in which the system includes both a near-field camera and a wide-field camera, the near- and wide-field cameras can be arranged on the end effector, laterally offset by a known distance, and can be arranged with overlapping fields of view. For example, the wide-field camera may exhibit minimum optical distortion proximal the center of its field of view; the near-field camera and the wide-field camera can therefore be arranged on the robotic arm such that the field of view of the near-field camera intersects the center of the field of view of the wide-field camera proximal the working plane at the interaction surface on the end effector, as described above.

The wide-field camera and near-field camera can also be longitudinally offset. For example, the near-field camera can be arranged longitudinally aft (i.e., behind) the wide-field camera to compensate for the longer focal length of the near-field camera.

Both the wide-field camera and near-field camera can also be arranged on the end effector or on a joint between a last link and the end effector on the robotic arm such that the wide-field camera and near-field camera move with the end effector, thereby enabling the system to register motion of the end effector directly to features detected in images recorded by these cameras based on known, fixed positions of these cameras relative to the end effector.

### 4.4 Varied-Resolution Stereo Vision

Because the fields of view of the wide-field camera and near-field camera overlap, the system can implement 3D reconstruction techniques—substantially in real-time—to stitch a near-field image recorded by the near-field camera and a wide-field image recorded substantially concurrently by the wide-field camera into a 3D image (e.g., a 3D point cloud) of a working volume around the robotic arm. For example, the system can stitch a high-resolution near-field image and a region of a concurrent wide-field image directly into a 3D image of this primary subvolume of the working volume of the robotic arm at this time. In this example, the system can also: implement structure from motion techniques to estimate 3D structures outside of this primary subvolume of the robotic arm's working volume based on the remainder of the wide-field image, preceding wide-field images, and poses of the robotic arm—and therefore positions of the wide-field camera—when these wide-field images were recorded; and incorporate representations of these 3D structures into the 3D image for the current time.

The system can thus: implement 3D reconstruction techniques to compile (substantially) concurrent 2D near-field and wide-field images into a high-resolution 3D representation of a primary subvolume local (e.g., tied to) to an interaction surface on the end effector; implement structure from motion techniques to transform a series of wide-field images into a lower-resolution 3D representation of structures around the robotic arm (and outside of the primary subvolume; and combine the high-resolution 3D representation of a primary subvolume and the lower-resolution 3D representation of structures outside the primary subvolume into a 3D image representing surfaces around the robotic arm at resolutions proportional to proximity to the interaction surface(s) on the end effector.

The system can thus include a wide-field camera and a near-field camera and merge 2D images recorded by both to achieve variable-resolution stereo vision, including 3D images of the field around the robotic arm that contain high-resolution data sufficient to inform local (e.g., “micro” or high-precision) movements near a target surface and lower-resolution data to inform more global (e.g., “macro” or lower-precision) movements over greater distances within the working volume of the robotic arm.

### 5. Single-Point Depth Sensor

In one variation shown in FIG. 2, the system further includes an optical emitter (e.g., an infrared LED or LASER diode) with a lens configured to focus (e.g., collimate) light output by the optical emitter into the field coincident the field of view of the near-field camera at the working plane.

For example, the optical emitter can output monochromatic light at a wavelength sensible by the near-field camera (and by the wide-field camera), such as approximately 465 nm, which may be sensible by red subpixels in the image sensor of the near-field camera. In this example, the optical emitter can be arranged on or near the end effector, such as adjacent and offset from the near-field camera by a known distance. In this example, the optical emitter can project a focused beam of light into the field of view of the near-field camera, wherein the spot size of the beam at the working plane approximates the area of a field of view of a single pixel (or a small contiguous cluster of pixels) in the near-field camera at the working plane. A reflection of the beam by a surface near the working plane and within the field of view of the near-field camera may thus illuminate a singular pixel (or a small contiguous cluster of pixels) in the near-field camera. (Similarly, the optical emitter can be configured to project the beam into the field of view of the near-field camera such that the spot size of the beam at the working plane approximates a pitch distance between fields of view of adjacent pixels in the near-field camera at the working plane such that only one or a small contiguous cluster of pixels in the near-field camera is illuminated by the optical emitter.)

In this variation, when light is generated by the optical emitter and projected into the field of view of the near-field camera, some of this light can be reflected by a nearby surface into the near-field camera to illuminate a singular pixel (or a small cluster of pixels) in the near-field camera. For example, when the system activates the optical emitter, light thus projected into the field by the lens may be reflected back to a singular pixel (or a small cluster of pixels) in the near-field camera at sufficient intensity to be distinguishable from other light—originating from other light sources near the robotic arm—incident on pixels within the near-field camera. The near-field camera can thus record a near-field image representing intensities of light incident on the near-field camera sensor, such as including intensities of red, green, and blue light incident on red, green, and blue subpixels in each pixel in the near-field camera sensor.

The system can then scan this near-field image (e.g., the red channel in the near-field image) for a particular pixel (or a centroid of a small cluster of pixels) recording significantly greater intensity of incident light (e.g., red light near the infrared band, specifically) than nearby pixels or all other pixels in the near-field image. Because the position of the lens and the angle of the beam output from the lens relative to the near-field camera are known, the system can then implement a trigonometry function and a calibration model to transform a longitudinal position of the particular pixel in the near-field image into a (high-resolution, high-precision) distance from the near-field camera to a surface coincident the beam.

The system can then tag the particular pixel (and pixels immediately adjacent the particular pixel) with this distance. When merging the near-field image and the wide-field image to generate a varied-resolution 3D image of the working volume, as described above, the system can also implement this distance as a ground truth value to calibrate distances in the 3D image or to otherwise adjust positions of points or adjust distances represented in the 3D image to this measured distance value. The system can additionally or alternatively implement this distance value to recalculate a local speed and/or local trajectory of the end effector as the end effector nears a target surface in light of other data extracted from the same 2D near-field image.

The wide-field camera can similarly capture the beam—reflected from a surface in its field of view—in a wide-field image. The system can implement similar methods and techniques to: scan this wide-field image for a particular pixel recording significantly greater intensity of incident light than nearby pixels or all other pixels in the wide-field image; implement a trigonometry function and a calibration model to transform a longitudinal position of the particular pixel in the wide-field image into a distance from the wide-field camera to the surface coincident the beam; and then adjust or calibrate the 3D image accordingly.

Furthermore, if the system detects the beam in both a near-field image and a concurrent wide-field image, the system can implement a) the lateral position and longitudinal position of particular pixels recording the beam in the wide- and near-field images and b) distances calculated accordingly for the wide and near-field images to coerce the concurrent wide and near-field images into alignment when transforming these 2D images in a 3D image of the working volume around the robotic arm, which may reduce error in the 3D image and/or enable the system to converge on a solution that merges the 2D wide- and near-field images into the 3D image.

Therefore, the system can leverage a 2D optical sensor containing many (e.g., millions) of pixels: to collect 2D (i.e., width and height) images of a working volume around the robotic arm; and to record a small, focused beam of high-intensity light emanating from a known location and at a known angle from the robotic arm relative to the 2D optical sensor. The system can then transform a position of a pixel in the 2D optical sensor defining a field of view that coincides incidence of the beam on a surface into a distance from the 2D optical sensor to this surface, thereby extracting data in a third dimension (i.e., distance) from the 2D image recorded by the 2D optical sensor. In particular, the system can combine an optical emitter that focuses a small, collimated beam into a field of view of a 2D optical sensor to extend 2D images recorded by the 2D optical sensor into a third dimension (i.e., “depth”). The system can then leverage such distance values to: improve reconstruction of 2D images from separate 2D optical sensors into 3D images; calibrate such 3D images; or directly influence local path planning of the robotic arm; etc.

The system can also implement the foregoing methods and techniques continuously during operation of the robotic arm (i.e., with each near-field image and/or wide-field image recorded by these cameras). Alternatively, the system can implement the foregoing methods and techniques continuously intermittently, such as once per second or a rate inversely proportional to estimated distance to a target object.

### 6. Surface Profile: Non-Collimated Beam

In a similar variation shown in FIG. 3, the system includes an optical emitter that projects a non-collimated light beam—at a wavelength sensible by the near-field camera—into the field of view of the near-field camera such that the geometry (e.g., scale) of the beam varies as a function of distance from the optical emitter to an incident surface in the field around the robotic arm. For example, the optical emitter can project a beam of monochromatic light at 465 nanometers into the field of view of the near-field camera to form a two-millimeter by one-millimeter ellipsoidal spot at the working plane parallel to the near-field camera and passing through the interaction surface on the end effector. Therefore, upon detecting this spot in a near-field image recorded when the optical emitter was active, the system can calculate a distance from the optical emitter to this spot based on a size of the spot. Because the geometry of the spot may also vary as a function of angle of the incident surface to the optical emitter—or more generally as a function of surface profile of the surface relative to the optical emitter—the system can also interpret an angle and/or a profile of the surface at the spot based on a geometry of the spot.

In this implementation, the ellipsoidal spot may be of sufficient size in the field of view of the near-field camera to be recorded by a contiguous cluster of pixels in the near-field image sensor, thereby enabling the system to distinguish both the position and the geometry of the spot on a surface recorded in a near-field image. However, the ellipsoidal spot projected onto this surface by the optical emitter may be sufficiently small to avoid overwhelming the field of view of the near-field camera such that a near-field image output by the near-field camera when the optical emitter is active predominantly records color information of surfaces near the interaction surface, thereby enabling the system to distinguish these surfaces in the near-field image and to continue to register motion of the robotic arm to these surfaces.

In this implementation, the system can continuously or intermittently activate the optical emitter to project the non-collimated light beam into the field of view of the near-field camera. Upon receipt of a near-field image recorded when the optical emitter was active, the system can: scan a color channel—at or near the output wavelength of the optical emitter—in the near-field image for a near-step increase in light intensity around a small contiguous cluster of pixels; calculate a closed spline area that best fits the perimeter pixels in the cluster; and implement a parametric or non-parametric model to transform the scale and geometry of the closed spline area into an average, maximum, and/or minimum distance from the optical emitter to the coincident surface in the field. The system can also transform the scale and geometry of the closed spline area into an average angle of surface to the optical emitter and/or a 3D surface profile of the coincident surface at the spot. For example, if the system detects only a scalar change (and not a skew change) in the spot in the near-field image, the system can: transform the scale of the spot directly into distance from the optical emitter to the coincident surface; and characterize the coincident surface as planar and parallel to the optical emitter at the spot. However, if the system determines that the spot exhibits a vertical skew (e.g., the aspect ratio of the ellipsoidal geometry of the spot is greater than a known aspect ratio of the optical emitter), the system can: calculate an angle of the coincident surface—at the spot—relative to the vertical axis of the optical emitter; and transform the maximum width of the spot into a distance from the optical emitter to the coincident surface at the center of the spot. Similarly, if the system determines that the spot exhibits an horizontal skew (e.g., the aspect ratio of the ellipsoidal geometry of the spot is less than a known aspect ratio of the optical emitter), the system can: calculate an angle of the coincident surface—at the spot—relative to the horizontal axis of the optical emitter; and transform the maximum height of the spot into a distance from the optical emitter to the coincident surface at the center of the spot.

The system can then transform these distances or angles from the optical emitter to the coincident surface in the field into a distance and angle from the near-field camera (or from the optical emitter, the end effector, or the interaction surface) to the coincident surface based on a known offset and orientation of the optical emitter to the near-field camera (or the optical emitter, the end effector, or the interaction surface). The system can then incorporate these data into the 3D image to calibrate or otherwise adjust the 3D image, as described above.

Therefore, in this variation, the system can: leverage the 2D color near-field camera to record both color information of a field around the interaction surface on the end effector and geometry information of non-collimated light also projected into the field in a single near-field image; and then transform a specific region of the near-field image representing coincidence of this non-collimated light onto a surface in the field into a distance value and surface profile. The system can implement similar methods and techniques to detect this non-collimated light in a wide-field image output by the wide-field camera while the optical emitter is active.

### 7. Surface Profile: Coherent Light Patterns

In a similar variation shown in FIG. 4, the system can include an optical emitter configured to output monochromatic light—at a wavelength sensible by the near-field camera (e.g., approximately 465 nanometers sensible by red subpixels in the image sensor of the near-field camera)—though a pair of parallel, horizontal slits that project an horizontal interference pattern into the field of view of the near-field camera. Distances between parallel lines where light—projected from the horizontal slits—constructively interferes at a surface in the field of view of the near-field camera can vary as a function of distance from the surface to the horizontal slits. The system can therefore: detect this horizontal interference pattern in a near-field image recorded by the near-field camera while the optical emitter is active; extract pixel distances between these horizontal lines in the near-field image; transform these pixel distances into distances from the optical emitter to the coincident surface(s) represented in the near-field image; and/or interpret a profile of the surface of the surface(s) relative to the optical emitter. The system can also transform these distances and/or surface profile(s) relative to the optical emitter into distances and/or surface profile(s) relative to the near-field camera (or relative to the end effector, or relative to the interaction surface) based on a known offset from the horizontal slits in the optical emitter to the near-field camera (or to the end effector, or to the interaction surface).

In one implementation, the system selects a near-field image recorded during activation of the optical emitter and then implements computer vision techniques to scan a color channel in the near-field image—corresponding to the output wavelength of the optical emitter—for discrete, vertically-offset, substantially parallel, and contiguous lines of pixels exhibiting peak light intensities (or “peak lines”). The system can then calculate a distance “D” from the optical emitter to a region of a surface represented in the near-field image between a center peak line and a second peak line according to a parametric model D=(dy)/((m+1)λ), wherein “d” is a distance between the two horizontal slits, “y” is the distance between the center peak line and the second peak line, “m” is the number of peak lines between the center peak line and the second peak line, and “λ” is the wavelength of light output by the optical emitter.

For example, for a planar surface within the field of view of the near-field camera and normal to the optical emitter, the horizontal interference pattern may manifest across the surface as horizontal, linear peak lines with adjacent peak lines vertically offset by a constant distance. The system can then detect these horizontal, linear peak lines in the near-field image, characterize the surface as planar and normal to the optical emitter given linearity of the peak lines and uniform offset between adjacent peak lines, and transform the offset between adjacent peak lines—in pixel space—in the near-field image into a distance from the optical emitter to the surface in real space according to the parametric model described above.

In another example, for a planar surface within the field of view of the near-field camera but inclined vertically away from the optical emitter, the horizontal interference pattern may manifest across the surface as horizontal, linear peak lines with adjacent lower peak lines vertically offset by shorter distances than adjacent upper peak lines in the near-field image. The system can then detect these horizontal, linear peak lines in the near-field image, characterize the surface as planar given linearity of the peak lines, transform the vertical offset between adjacent peak lines—in pixel space—near the bottom of the near-field image into a distance from the optical emitter to a lower region of the surface in real space, similarly transform the vertical offset between adjacent peak lines—in pixel space—near the top of the near-field image into a distance from the optical emitter to an upper region of the surface in real space, and interpolate distances from the optical emitter to other regions of the surface between these lower and upper distances.

In yet another example, for a planar surface within the field of view of the near-field camera but angled horizontal from the optical emitter, the horizontal interference pattern may manifest across the surface as linear peak lines with short vertical offset distances between adjacent peak lines at the left side of the near-field image representing the near side of the surface from the optical emitter and with greater vertical offset distances between adjacent peak lines at the right side of the near-field image representing the far side of the surface from the optical emitter. The system can then detect these horizontal, linear peak lines in the near-field image, characterize the surface as planar given linearity of the peak lines, transform the vertical offset between adjacent peak lines—in pixel space—near the left side of the near-field image into a distance from the optical emitter to the near side of the surface in real space, similarly transform the vertical offset between adjacent peak lines—in pixel space—near the right side of the near-field image into a distance from the optical emitter to a right side of the surface in real space, and interpolate distances from the optical emitter to other regions of the surface between these left and right regions of the surface accordingly.

In another implementation, the system can: detect multiple peak lines—exhibiting greatest intensities in a color channel matched to the output of the monochromatic light source—extending approximately horizontally across a near-field image; and segment these approximately-horizontal peak lines into columns, such as one-pixel-wide columns or ten-pixel-wide columns. For the center column, the system can extract distances between adjacent, vertically-offset peak pixels represented in the center column (e.g., peaks at the center of or averaged across the center column) in the near-field image. For a first peak pixel in the center column, the system can implement a calibration table or parametric model—such as described above—to transform a first distance from the first peak pixel to a second peak pixel above the first peak pixel and a second distance from the first peak pixel to a third peak pixel below the first peak pixel into a distance from the optical emitter to a point on a surface—in the field—coinciding with the first peak pixel in the near-field image. The system can then repeat this process for each other peak pixel in the center column to form a 1D vertical array of distances from the optical emitter to vertically-offset peak pixels in this column. The system can also repeat this process for each other column segmented from the near-field image to form additional arrays of distances from the optical emitter to vertically-offset peak pixels in these other columns, corrected based on horizontal distances from the center column to these other columns in the near-field image. The system can then compile these 1D distance arrays—each corresponding to one column segmented from the near-field image—into a 2D grid array of distances from the optical emitter to a surface in the field of view of the near-field camera and coincident the horizontal interference pattern output by the optical emitter. The system can also transform the 1D vertical array of distances thus extracted from a column of peak pixels in the near-field image or the 2D grid array of distances extracted from multiple columns in the near-field image into distances from the near-field camera to corresponding points on surfaces in the field to based on a known offset between the near-field camera and the optical emitter.

In the foregoing implementations, the system can include a similar optical emitter configured to project a vertical interference pattern into the field of view of the near-field camera; and the system can implement similar methods and techniques to detect vertical peak lines in a near-field image recorded by the near-field camera when the vertical optical emitter is active and to transform the vertical peak line into distances from the optical emitter (or the near-field camera) to surfaces in the field of view of the near-field camera.

Furthermore, the system can compile distances from the horizontal and vertical optical emitters to surfaces in the field of view of the near-field camera to generate or correct a 3D image of a field around the end effector. For example, the system can implement methods described above to: project a horizontal interference pattern into the field of view of the near-field camera and record a first near-field image at a first time; project a vertical interference pattern into the field of view of the near-field camera and record a second near-field image at a second time; extract a 1D vertical array of distances and/or a 2D grid array of distances from the first near-field image, as described above; extract a 1D horizontal array of distances and/or a 2D grid array of distances from the second image, as described above; transform these 1D linear arrays and/or 2D grid arrays of distances from corresponding horizontal and vertical optical emitter surfaces in the field of view of the near-field camera; confirm alignment between overlapping regions of the adjusted 1D linear arrays and/or 2D grid arrays; and compile these adjusted 1D linear arrays and/or 2D grid arrays given sufficient alignment. The system can then correct a 3D image—generated from the near-field image and a concurrent wide-field image, as described above—based on these compiled, adjusted 1D linear arrays and/or 2D grid arrays. In particular, the system can force a 3D image—generated by merging a near-field image and a concurrent wide-field image, as described above—into alignment with distances thus extracted from the 2D near-field image based on an interference pattern detected in this near-field image.

Alternatively, the system can project surfaces and edges detected in a 2D near-field image onto 1D distance arrays, 2D grid arrays of distances, or surface profiles calculated from an interference pattern detected in this same 2D near-field image to generate a 3D image of the volume around the end effector from this single 2D near-field image.

The system can implement similar methods: to detect peak lines in a wide-field image recorded during activation of the (horizontal and/or vertical) optical emitter; to transform locations of these peaks into distances from the optical emitter(s) to surfaces in the field of view of the optical emitter(s); and to correct or generate a 3D image of the working volume around the robotic arm from these distance values derived from the wide-field image and 2D data stored in the wide-field image.

However, the system can implement any other method or technique to project light into the field of view of a 2D color camera to augment a dimensional capacity of the camera.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for deriving varied-resolution 3D information from 2D images, the method comprising:
at a first time, recording a 2D color near-field image through a first color camera arranged on a robotic arm proximal an end effector, the first color camera characterized by first focal length and defining a narrow field of view containing an interaction surface on the end effector;
at a second time approximating the first time, recording a 2D color wide-field image through a second color camera arranged on the robotic arm, the second color camera characterized by a second focal length less than the first focal length and defining a wide field of view containing the narrow field of view and a greater region of a working volume of the robotic arm;
reconstructing a first portion of a 3D image of the working volume proximal the interaction surface at a first resolution from the 2D color near-field image and a first region of the 2D color wide-field image that overlaps the 2D color near-field image; and
reconstructing a second portion of the 3D image at a second resolution less than the first resolution from the 2D color wide-field image and recent 2D color wide-field images output by the second color camera.

2. The method of claim 1, further comprising:
at the first time, projecting a light pattern into the narrow field of view of the first color camera, the light pattern characterized by a frequency detectable by the first color camera;
detecting the light pattern in the 2D color near-field image; and
calculating a distance from the first color camera to a surface in the narrow field of view based on a geometry of the light pattern detected in the 2D color near-field image;
projecting the distance into the 3D image; and
forcing reconstruction of the first position of the 3D image according to the distance.
